(19) United States
(12) Patent Application Publication
(10) Pub. No.: US 2022/0001979 A1
(43) Pub. Date: Jan. 6, 2022

(54) Air Equalizing Expanded Light Body Disk for Anti Gravitational Flight

(71) Applicant: Antoine D' angelo Barnes, St. Louis, MO (US)

(72) Inventor: Antoine D' angelo Barnes, St. Louis, MO (US)

(21) Appl. No.: 16/920,724

(22) Filed: Jul. 5, 2020

(51) Int. Cl. B64C 39/00

(52) U.S. Cl. CPC B64C 39/001

(57) ABSTRACT

What is flight? How do insects, birds, and planes fly through air? People have known about the four forces of flight; lift, drag, weight, and thrust that enables flight for many years. One of the forces, weight, is the force of gravity acting in a downward direction toward of the Earth. Gravity is defined as the force by which a planet or other body draws objects toward its center. What causes objects to be drawn in? What is the source of attraction? It is because the Universe is a system of light waves. In a light wave system all matter is a light projection onto the bodies of rotating vortexes while mass is the level of light compression the vortexes produce. The apple, a small or negative vortex, is pulled down by the Earth, a larger or positive vortex, directly beneath it. Gravitation is the interaction between large, positive vortexes and small, negative vortexes created by the way in which matter is constructed. Since the cause of gravity is the interaction of positive and negative vortexes, anti gravitation has to be the equalization of theses vortexes. The following invention is a device predicated on the idea on how to equalize these vortexes and presents new ways for society to think of flight.

### SUMMARY

The Earth, a feather, and a bowling ball are all light projections on spinning vortexes as a whole and each part within no matter how small. When a feather and bowling ball are dropped from a high distance in an evacuated chamber both are pulled down at the same rate by the vortexes that project the Earth under them. When the chamber is filled with air the feather falls slower than the bowling ball because the very small vortexes that project it are equalizing with the vortexes that project whats in the air. If it were possible for the feather to be turned on and of at a certain rate it would not it would be sit suspended in the air.

While rotating at high speed, helicopter rotors interchange with areas where there are no rotors which are called expanded light bodies. These expanded light bodies mainly consists of what's in the air, mainly nitrogen and oxygen. The atoms and subatomic particles that make up the air are lights projected onto the bodies of rotating vortexes that are very small. The rotors themselves are compressed light bodies that go through changes when in motion. While the rotors are spinning at high speed they are geometrically divided into sections small enough for the vortexes that project them to equalize with those that make up the air causing an affect similar to magnets repelling each other.

The Disk:

The Air Equalizing Expanded Light Body Disk works as an electrical rotor spinning rapidly and equalizing or repelling the vortexes that make up what is in the air. The body of the Disk represents the geometrically divided air filled space between the rotor blades. The spinning rotor blades are represented by an electric current that is introduced at different intervals to the individual geometrically divided body sections in the Disc body.

The body of the Disk is made from a non-space compressing material that does not react to the compressing vortexes that encompasses all matter. One characteristic of non-space compressing materials would be products that go back to their original shapes after being compressed. This is due to the structure of the vortexes from within that make up the material and the space compressing vortexes extending from it.

Vortexes of Space:

Extending from and surrounding all matter are the vortexes of space rotating and compressing light from space to the zero planes of positive and negative black bodies throughout space. We can think of these black bodies as males and females or the navels on our bodies. For instance, a black hole is a negative female (innie), where the vortexes of space compress light to it's center. The opposite, a black protrusion, is a positive male (outtie) that compresses light onto its surface producing white light. Stars are black protrusions. Stars and black holes are the “electrical circuits” of the Universe and they prove the vital significance of space compressing vortexes that extend from all objects.

As a glass of liquid water freezes it's expansion is a result of two vortexes acting on it in different ways causing it to expand and break the glass. One type of vortex that surrounds the glass of water causes it to compress at each narrow part of each vortex. As the water freezes and compresses at each narrow point it is pulled outward by the wide rotating side of another vortex causing the water to expand and break the glass.

### FIGURES

FIG. 1 Embodiment of Disc top view

FIG. 2 Embodiment of Disc standard view

FIG. 3 Profile view of Disc

FIG. 4 Embodiment of Disc body with geometrical divisions in the material

FIG. 5 Embodiment of Disc body with geometrical divisions in the material

FIG. 6 Embodiment of Disc top view with geometrical divisions in the body

FIG. 7 Embodiment of Disc body with geometrical divisions in the material

FIG. 7a Embodiment of Disc body with geometrical divisions in the material with space on top and bottom

FIG. 7a Animation: Interaction between Disc body and space as the sections are energized

FIG. 7c Animation: Energized section of Disc interacting with space

FIG. 25 Invisible white light

FIG. 12 Invisible white light (space)

FIG. 10 Light Wave field

FIG. 15 Invisible white light and the Light Wave field

FIG. 16 Light Wave field and Radio waves

FIG. 18 Light Wave field and Microwaves

FIG. 19 Light Wave field and Microwaves

FIG. 20 Light Wave field and Ultraviolet Light waves

FIG. 21 Light Wave field and Ultraviolet Light waves

FIG. 22 Invisible White Light (space) intersection

FIG. 23 Light Wave System Frame

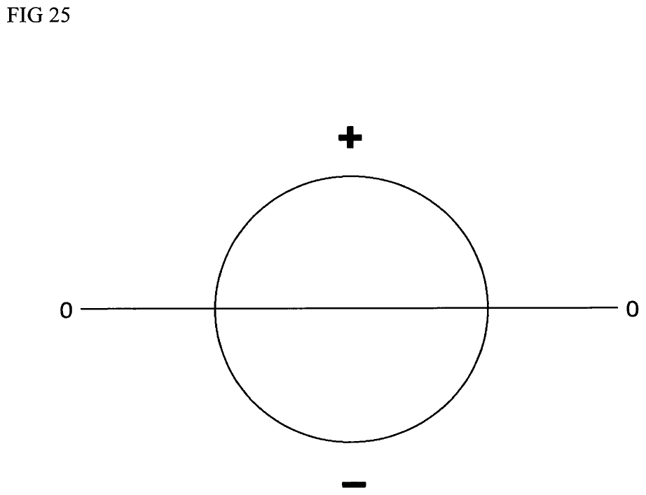

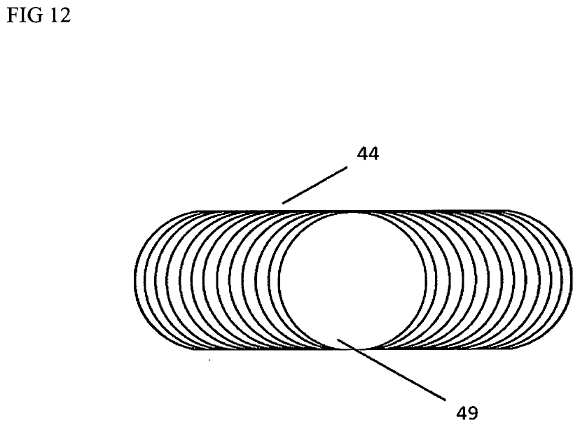

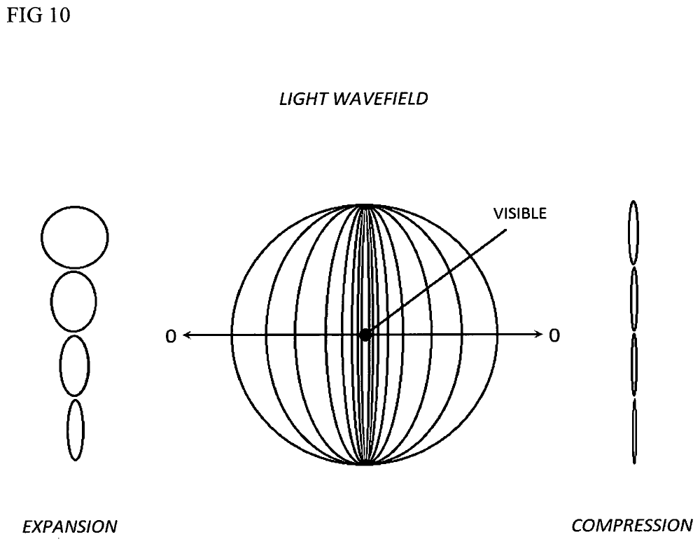

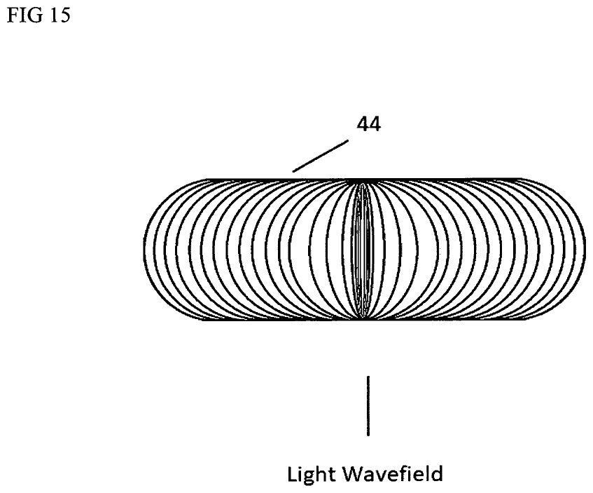

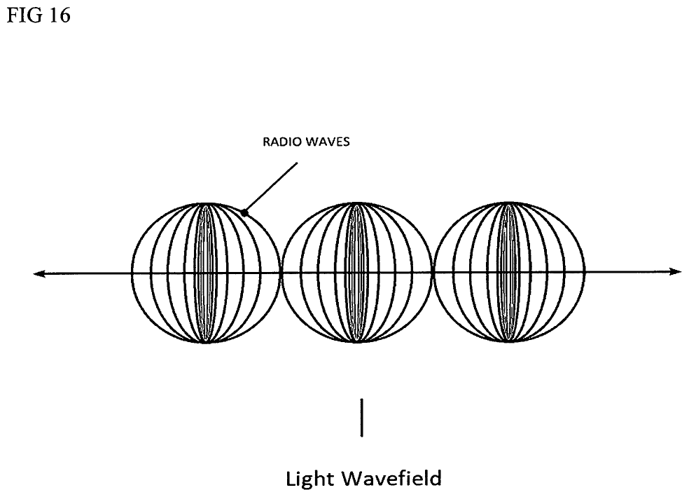

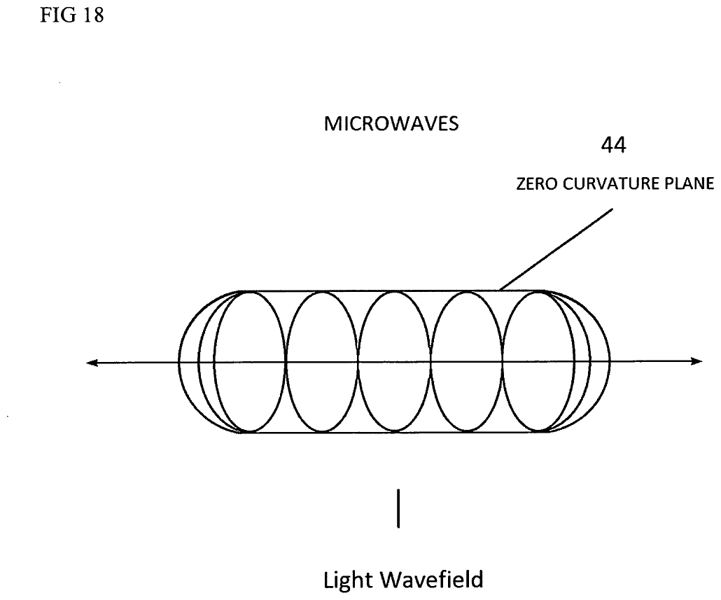

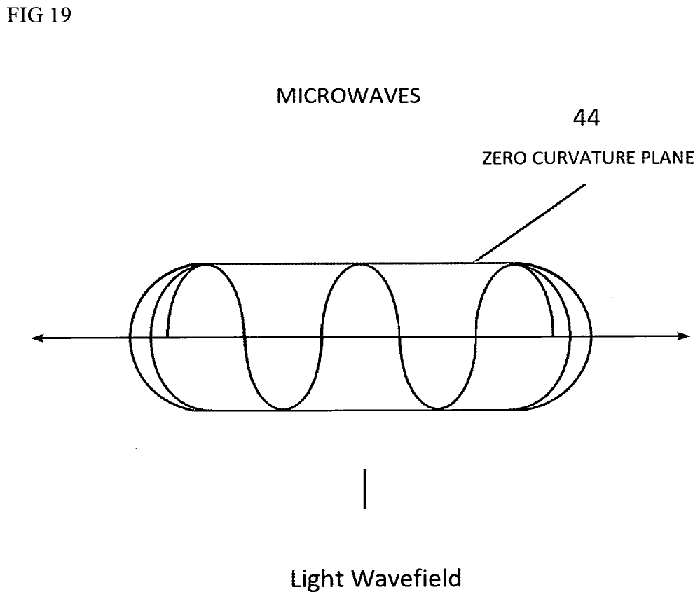

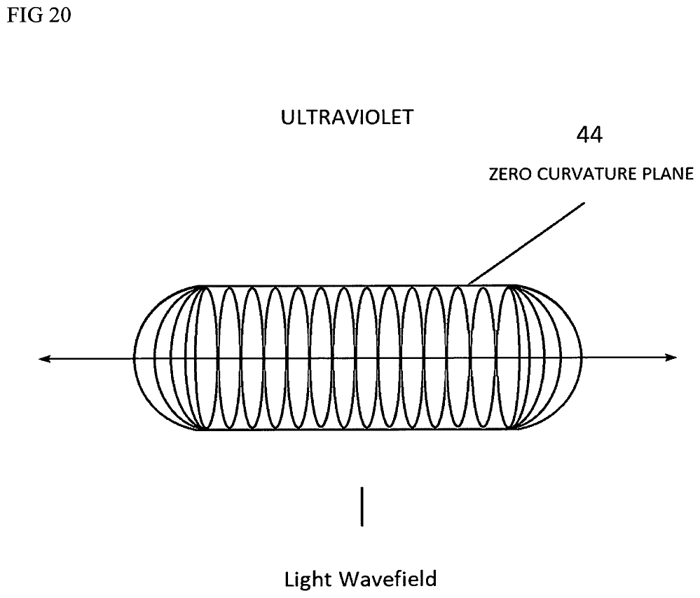

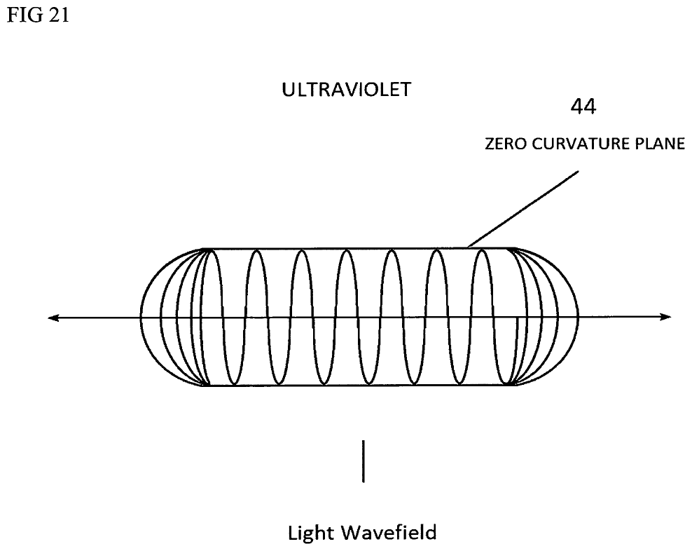

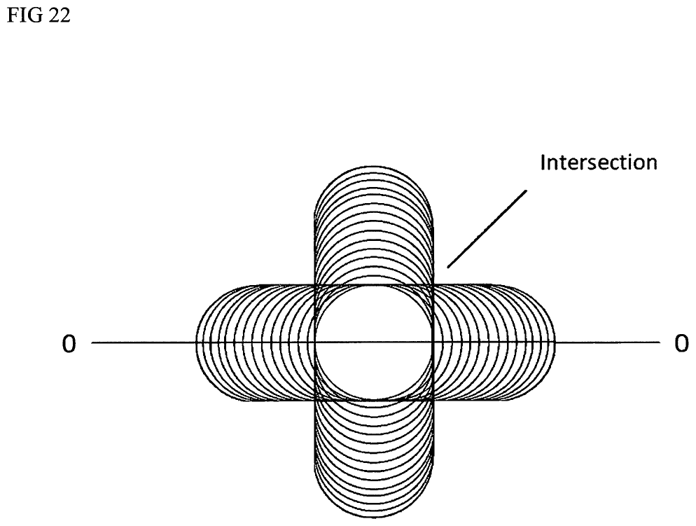

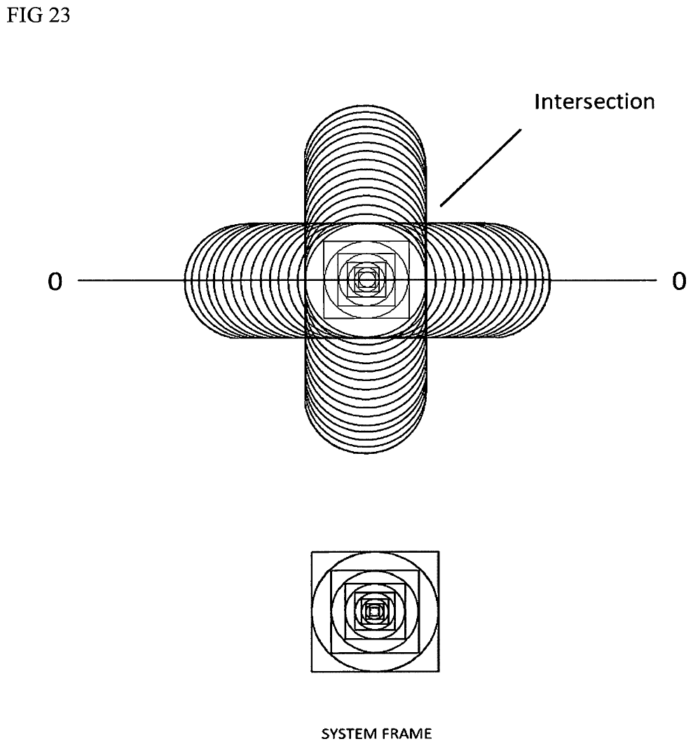

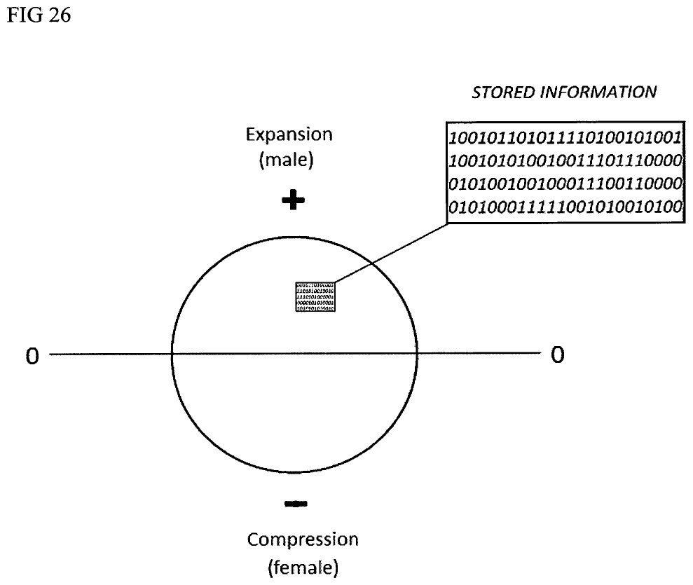

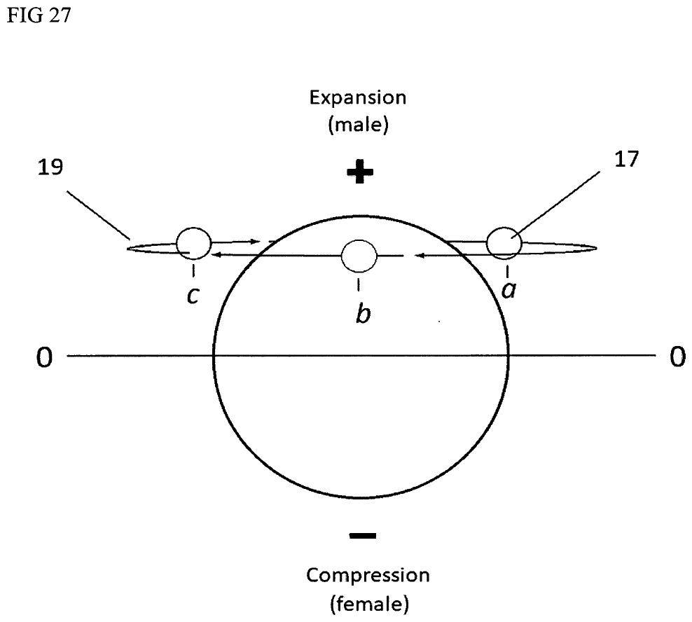

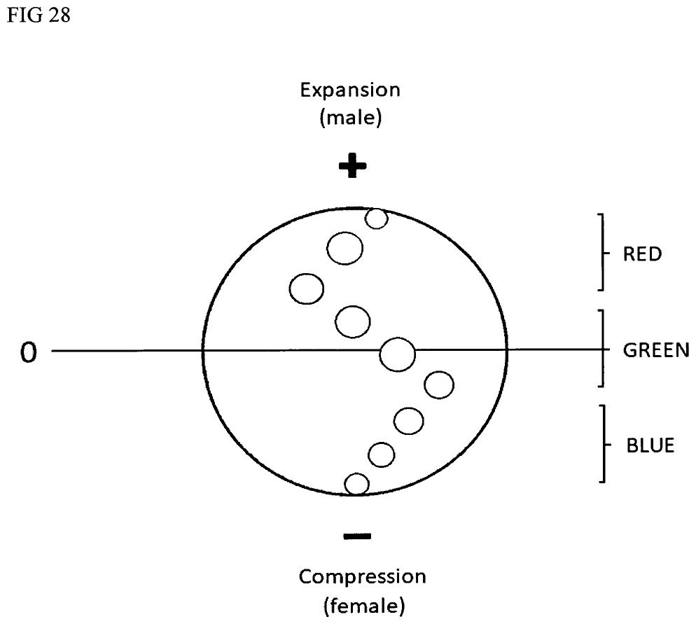

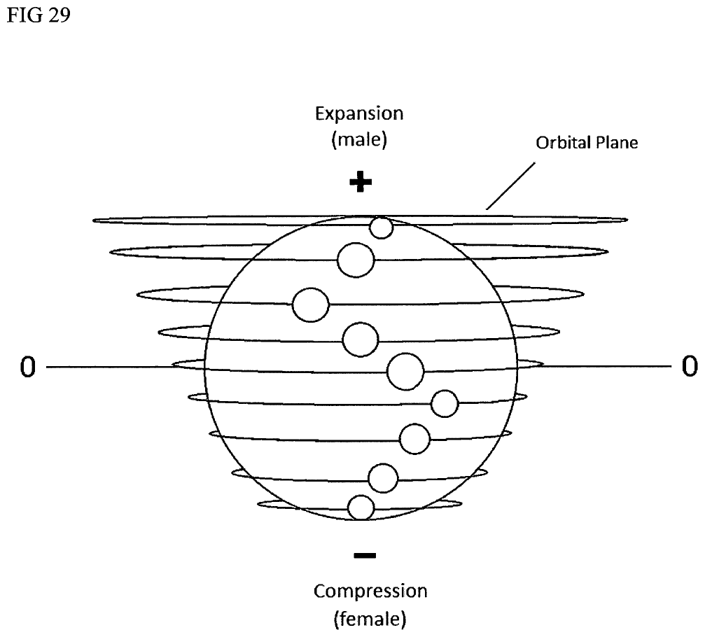

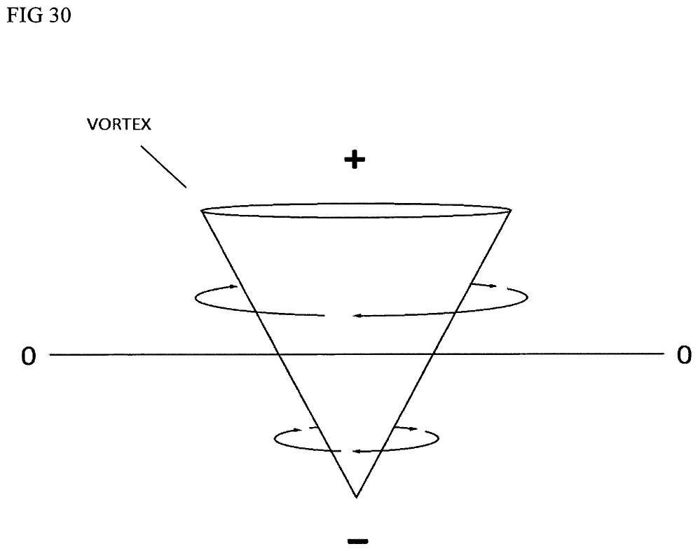

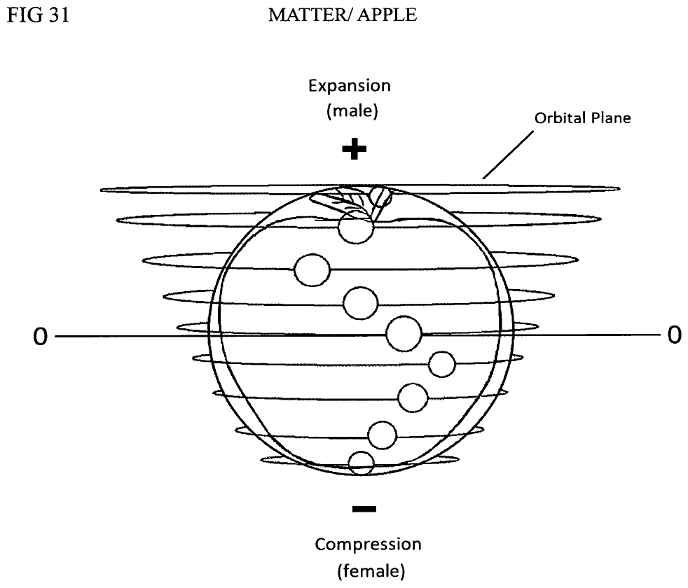

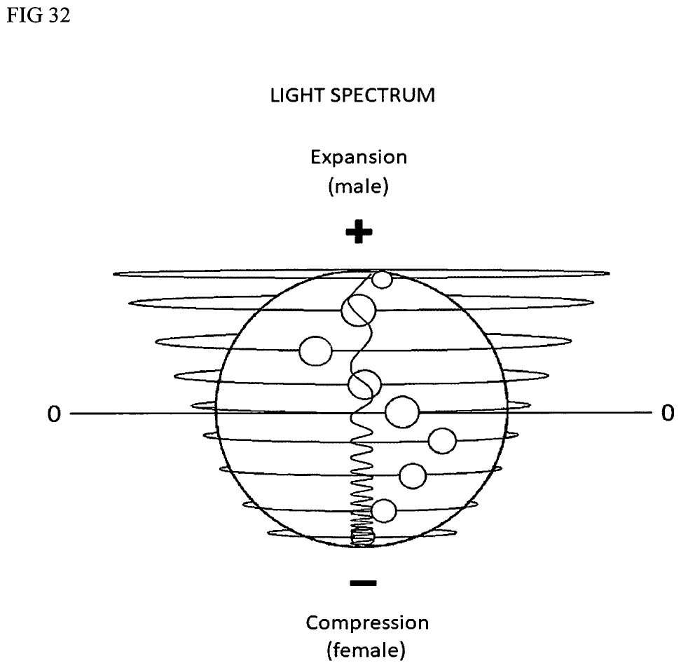

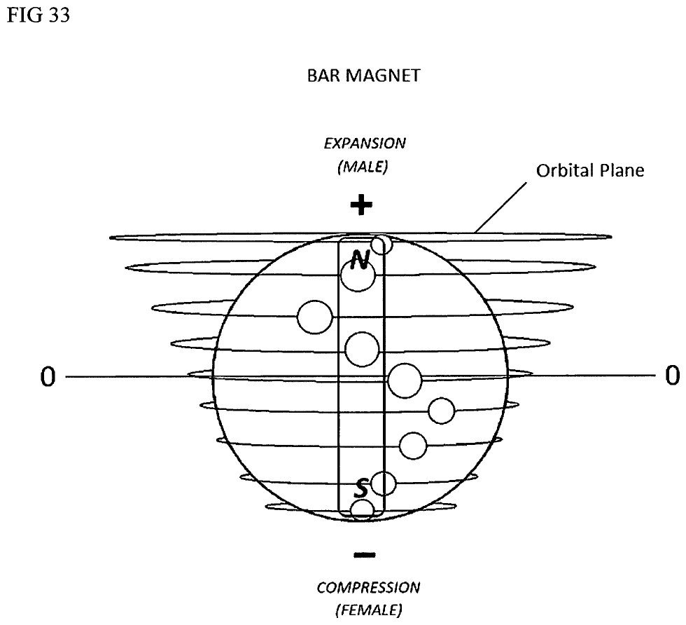

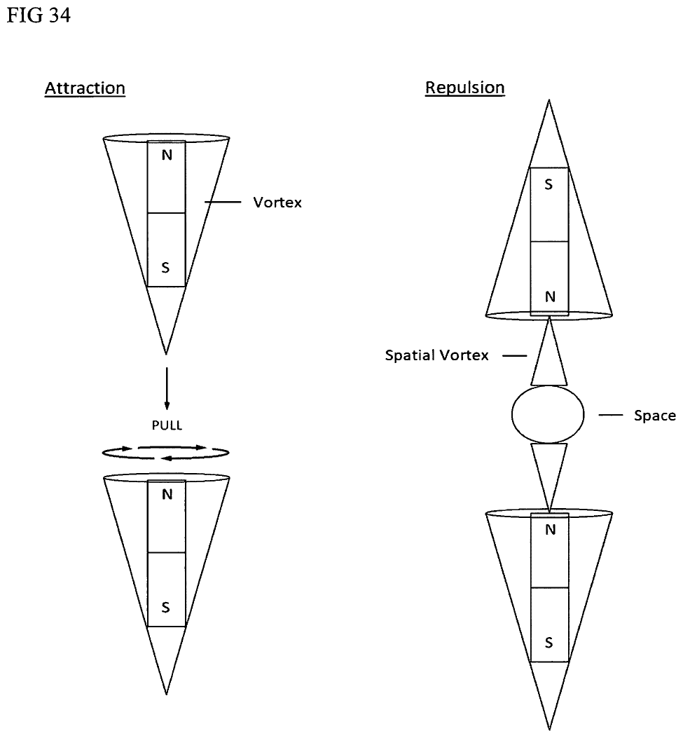

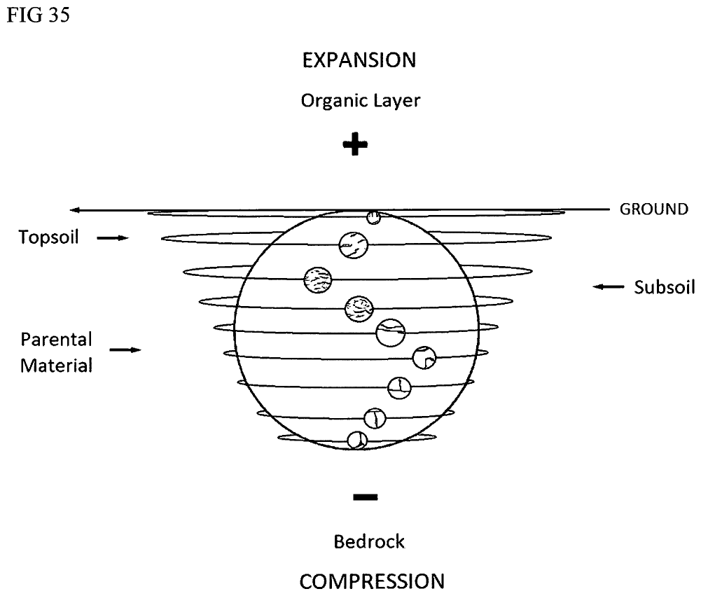

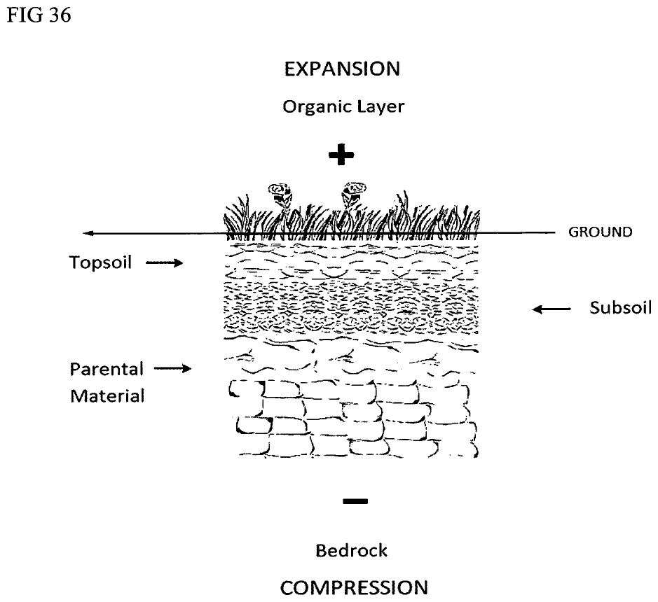

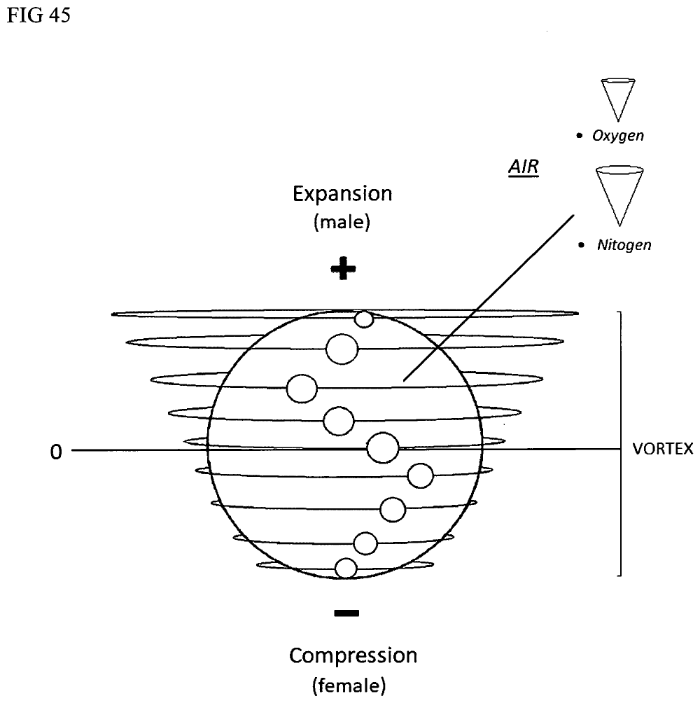

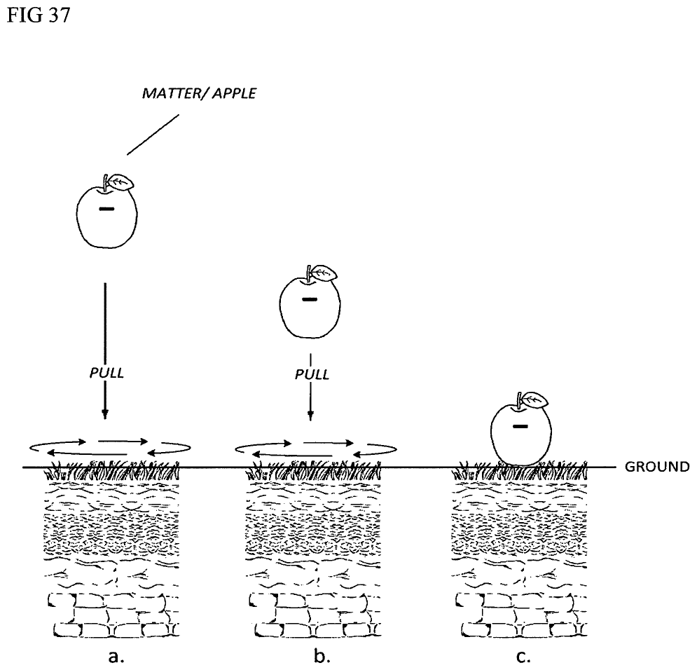

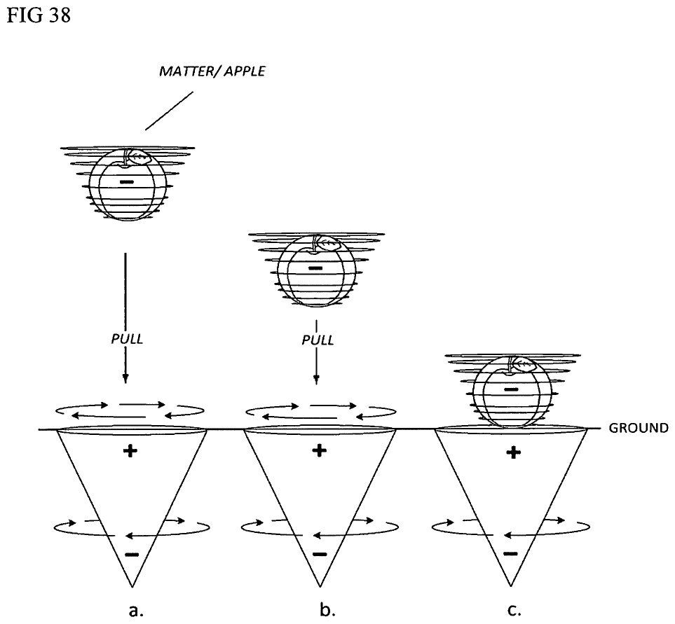

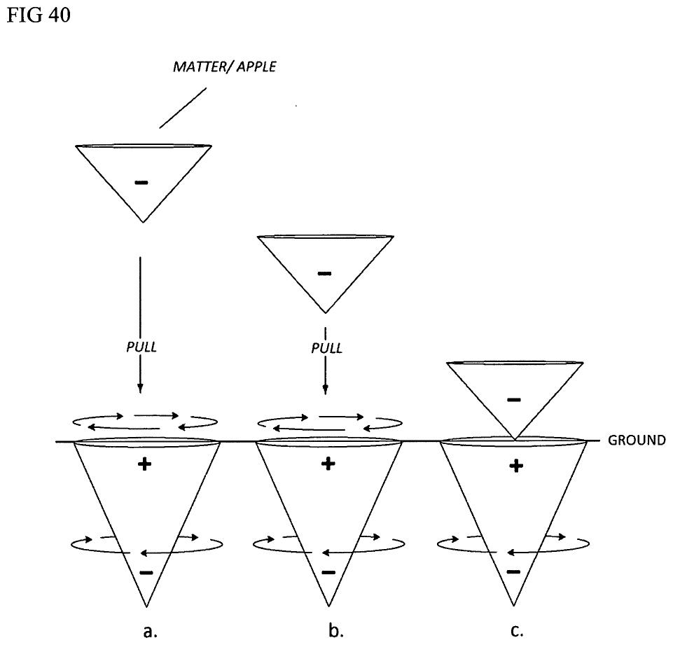

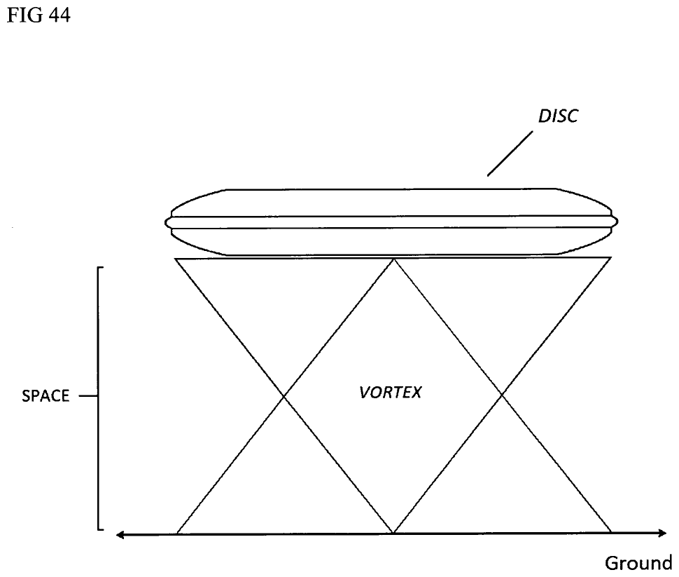

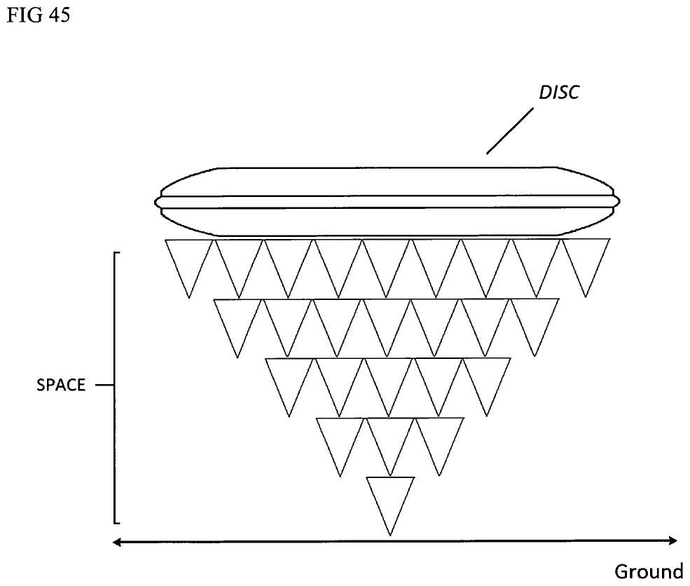

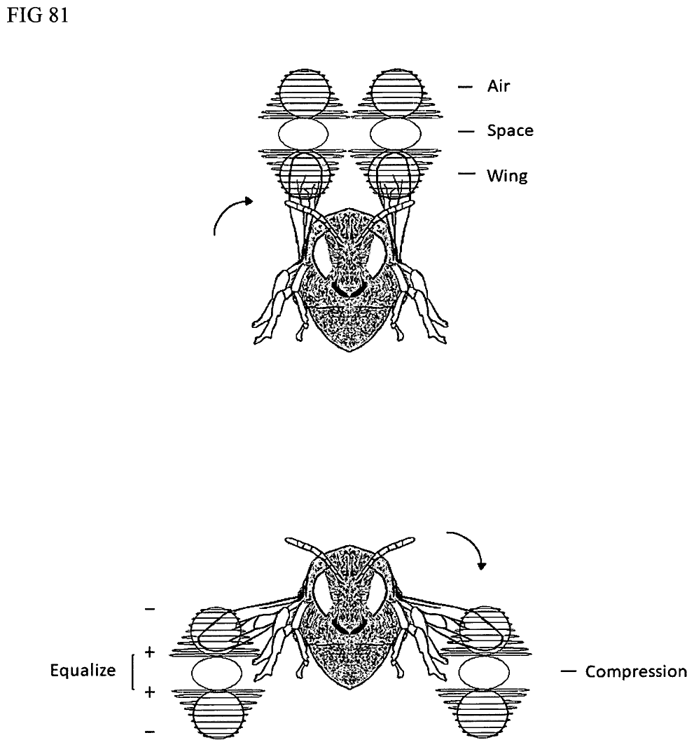

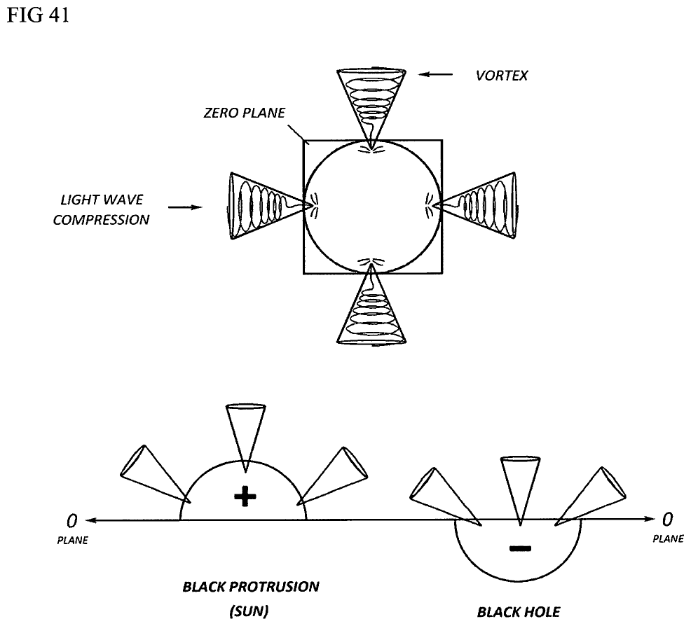

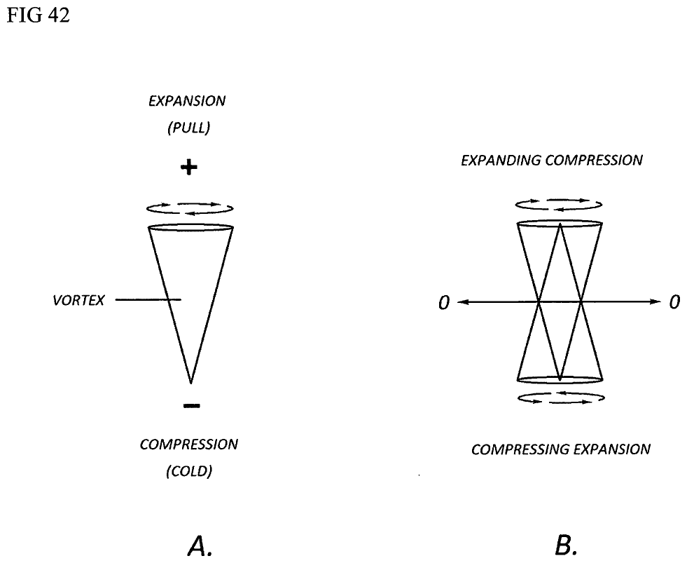

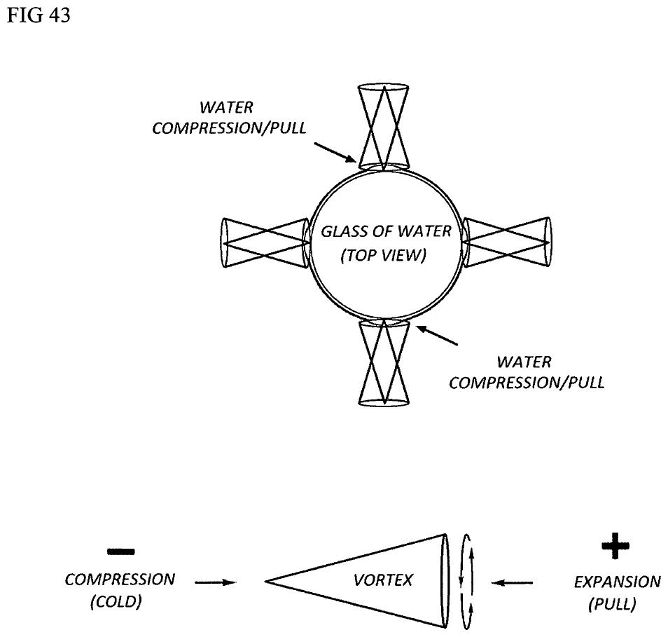

FIG. 25, 26 Invisible white light

FIG. 27 Invisible white light and rotating Scanning Light Orbitals

FIG. 28 Invisible white light, Scanning Light Orbitals (RGB)

FIG. 29 Invisible white light and orbital planes of the Scanning Light Orbitals

FIG. 30 Vortex created by the revolving Scanning Light Orbitals

FIG. 31 Simulated Light projection of Matter/Apple

FIG. 32 Simulated Light projection of the Light Spectrum

FIG. 33 Simulated Light projection of Matter/Bar Magnet

FIG. 34 Simulated Light projection of Matter/Bar Magnet interactions

FIG. 45 Simulated Light projection of Air

FIG. 81 Simulated Light projection of Matter/Wing and the Air equalizing/repelling each other while a Bee is in flight

FIG. 36 Simulated Light projection of the ground from the Organic Layer to the Bedrock

FIG. 35 Simulated Light projected onto the body of the orbitals to simulate the ground from the Organic Layer to the Bedrock

FIG. 37, 38, 40 Matter/Apple falling to the ground

FIG. 41 Showing the vortexes extending from objects in space and how the interact to create Sun's and Black Holes

FIG. 42 Properties of single and double vortexes

FIG. 43 Properties of single and double vortexes shows why liquid water expands when freezing

FIG. 44 Double vortexes of space keeping the Disc off the ground

FIG. 45 Embodiment of The Disc resting on many vortexes

The Disc:

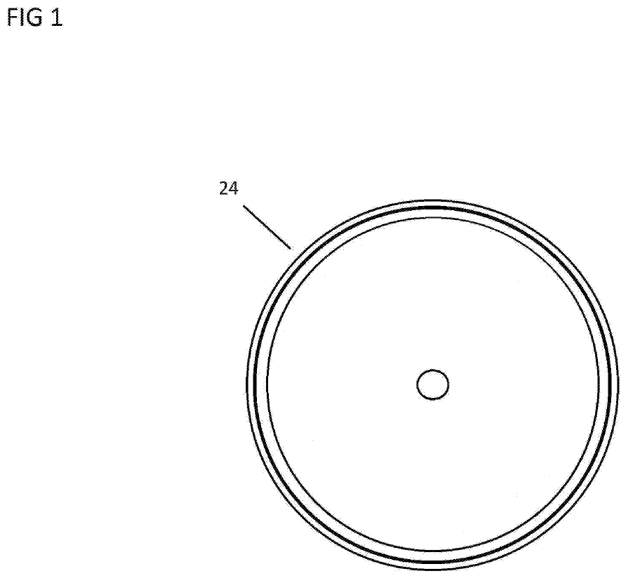

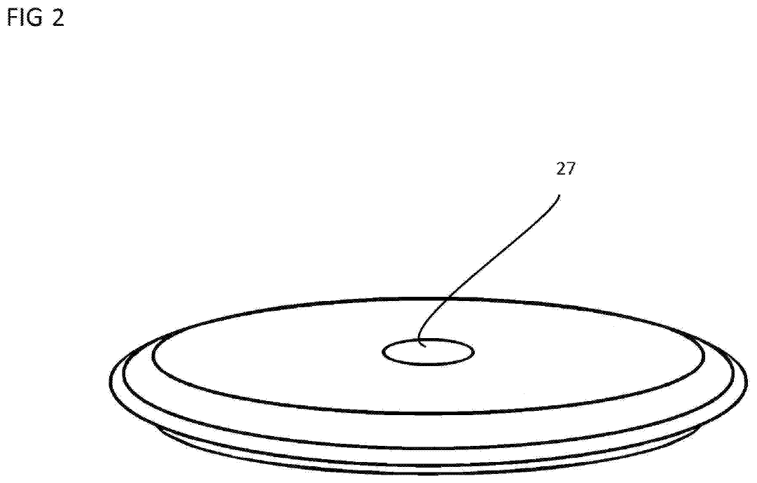

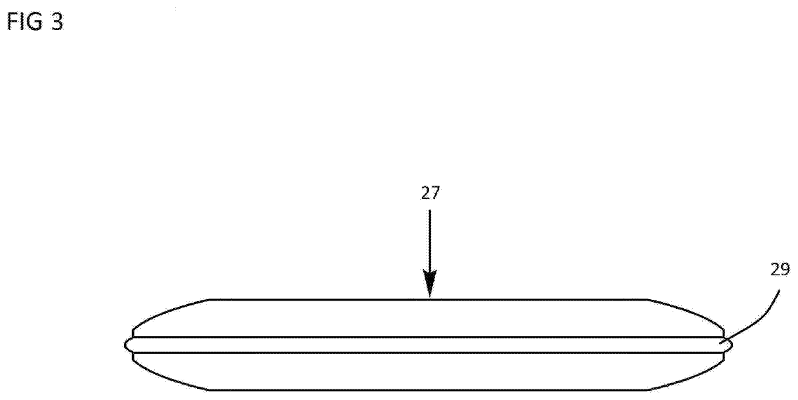

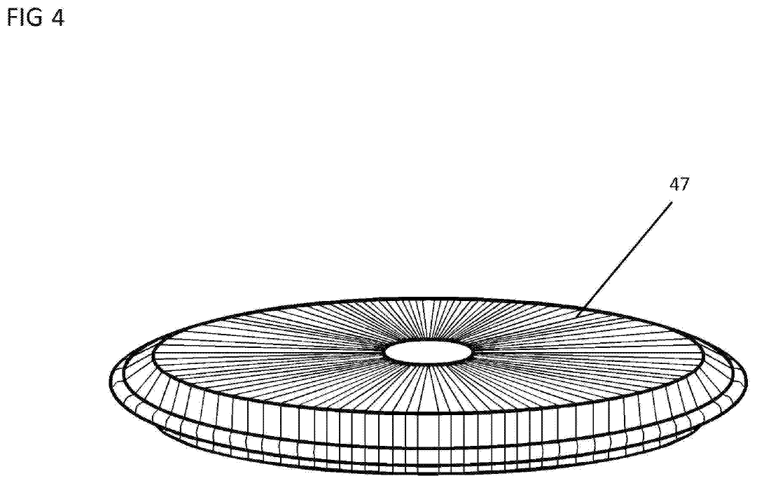

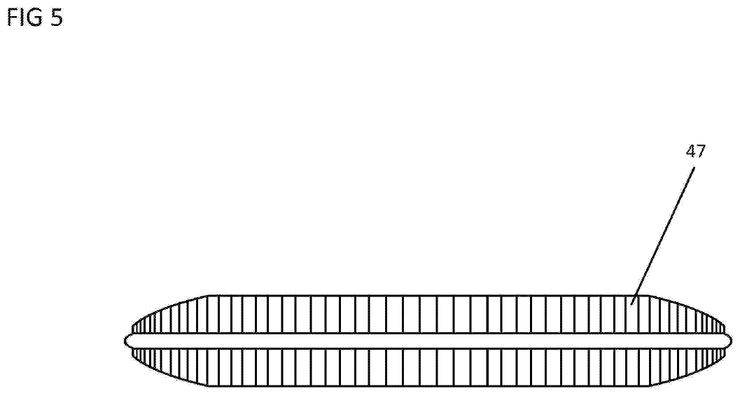

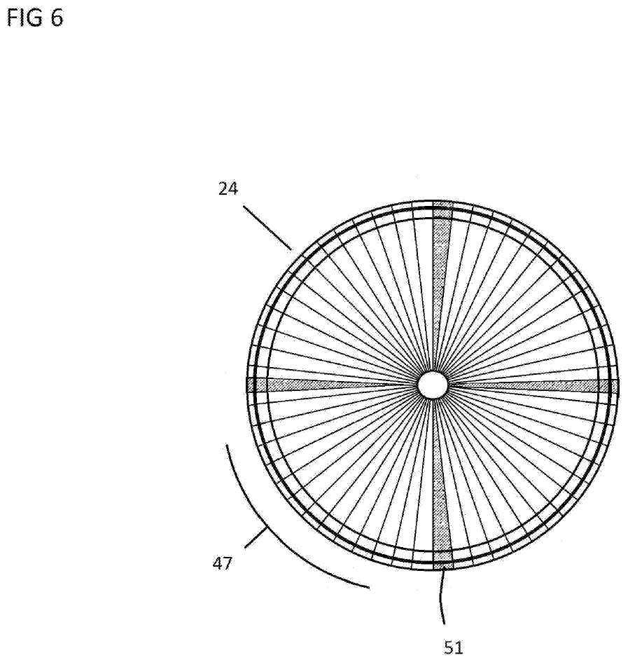

Referring to FIG. 1 is the embodiment of the top view of the 24 Disc wherein the the center of the 24 Disc is the FIG. 2 housing for the 27 power and electrical connections. The FIG. 3 top side and underside of the Disc may be connected by an embodiment of a 29 ridge. FIGS. 4 and 5 embodies a closer view of the non-space compressing material of the Disc body and the 47 patterned geometric layout therein with said pattern located throughout the whole of the Disc body from a central point.

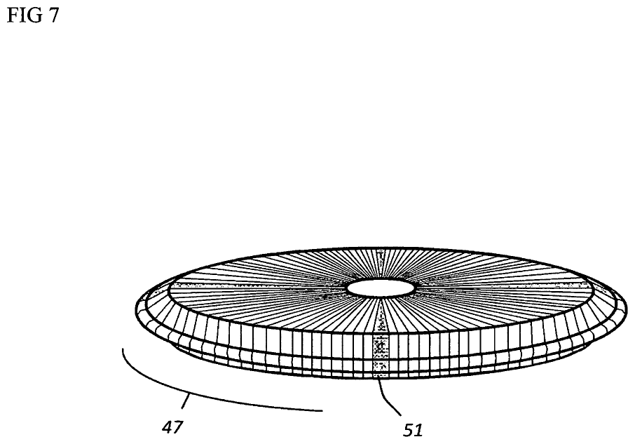

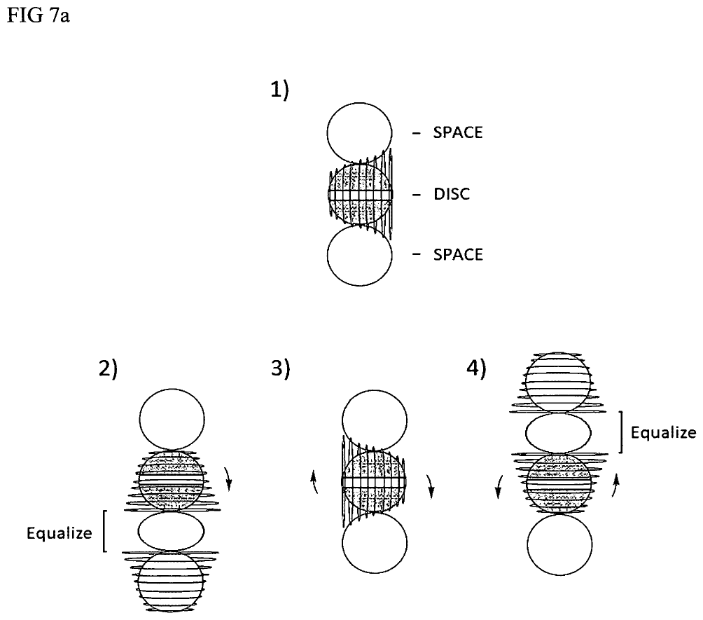

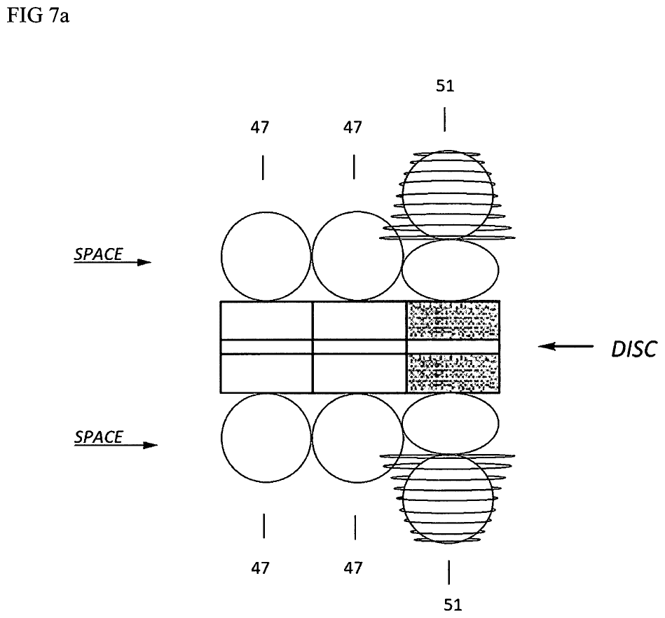

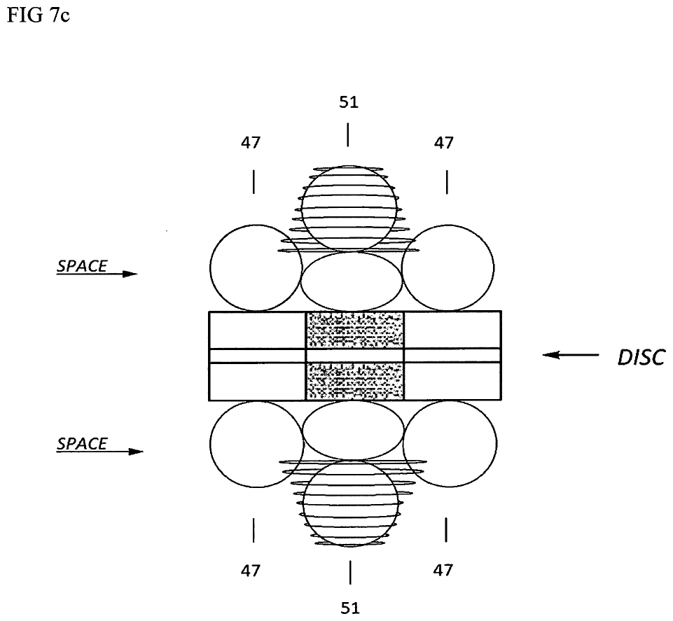

FIG. 6 embodies the top view of the 24 Disc with the 47 patterned geometric layout of the Disc body representing the empty space between helicopter rotor blades and 51 surface area represents the rotor blades. The 51 compressed surface areas are exposed to an electrical current received from FIG. 2 the 27 power and electrical connections unit at the center of the Disc. The 47 patterned geometric layout of the Disc body representing the empty space are the areas where there is NO electrical current present. Referring to FIG. 7 the four 51 compressed surface areas rotate in the same direction at short intervals interchanging between electric current ON or (1), or electric current OFF or (0) within the non-space compressing material of the Disc body and the 47 patterned geometric layout of the Disc. FIG. 7a This rapid interchange in the body of the Disc has an affect on the space around it. Referring to FIG. 7c this affect is the 59 equalization of the vortexes of space and the vortexes of 51 compressed surface areas the Disc body.

Gravitation is the interactions between large and small vortexes that occurs in a Light Wave System.

The Light Wave System/Gravitation:

Anti gravitation is the equalization of large and small vortexes in a Light Wave System. The following describes matter, gravitation, and what occurs during vortical equalization.

Referring to FIG. 25 the general bases of the Light Wave System is a background of magnetic 49 invisible white light. As shown in FIG. 12 the spheres of 49 invisible white light are configured in such a way that the edges form 44 zero curvature planes. Within the magnetic memory of the 49 invisible white light is the Light Wavefield stored. Referring to FIG. 10-21 the Light Wavefield is the FIG. 26 stored information of all light from Expanding Radio waves to Compressing cosmic rays with the visible light spectrum in the center.

Referring to FIG. 22 is the embodiment of intersecting spheres of 49 invisible white light forming a FIG. 23 System Frame in which spheres are enclosed in cubes wherein the straight lines of the cubes are formed from the 44 zero curvature planes of other spheres.

Referring to FIG. 31 Matter (simulated, compressed light) and FIG. 32 Light Spectrum is projected on the FIG. 27, 17 orbital body while rotating and revolving around the invisible FIG. 23 Light Wave System Frames. FIG. 29, 30 The fast motion and position of the FIG. 27, 19 orbital planes form a vortex wherein the wide top pulls down smaller vortexes.

Referring to FIG. 33 the bar magnet embodies the theory of gravitation wherein the positive north side of the magnet always pulls in the negative south side of the magnet and FIG. 34 showing how they repel or equalize by the motion of the spinning vortexes caused by the 17 orbital bodies.

Gravitation is the interaction between small and large vortexes.

FIG. 81 when a bee flies the vortexes of it's wings equalizes or repels the vortexes that make up particles in the air. Equalization occurs in a very short period of time therefore the wings need to move very fast to keep resetting the position of the vortexes. The vortexes of the Disc body electrically mimics how the bee repels vortexes of the particles in the air.

FIG. 36 The earth is simulated matter. The expanded or positive side of the spinning vortexes is the Organic layer while the Bedrock is the compressed, negative side.

FIG. 35 the layers are projected onto the orbital bodies as they revolve and spin rapidly causing the ground to pull matter back toward it.

FIG. 37, 38, 40 depicts everything smaller than the earth as negative and the spinning vortexes of the Earth is always positive or larger than the matter on it. Energy strengthens the power of the spinning vortexes that makes up matter.

As shown is FIG. 41 vortexes make up matter and extend from it through space and have a very big impact on how the Universe works. Light wave compression through the vortexes extending from black bodies of space is the reason the Sun shines and how black holes work.

We can think of the Sun and Black holes in terms of belly buttons.

The Sun is an outie black body protruding from the zero plane of space where the vortexes extending from it compress light waves in space on it's black surface resulting in “sparks” or Sun light.

Black Holes are innie black bodies sinking into the zero plane of space compressing light through it's extending vortexes to it's center.

FIG. 42, 43 Water expands as it freezes because as it solidifies or compresses on its surface the positive spinning vortexes from space pulls the water making it expand.

FIG. 44 Embodies anti gravitation wherein the empty space between any two objects is occupied by two large rotating vortexes that have many other vortexes within them.

As the body of the Disc rapidly changes from non-space compressing material of the Disc body to the compressing of the 47 patterned geometric layout therein through an electrical current causes the Disc body to sit on or hover on the positive side of the interchanging vortexes.

I claim:

1. A round device in the shape of a Disk in which the body is divided into geometrically shaped sections with an area in the center of the Disk is the housing for the electrical connections to the power source. The Disk body can be of any material that produces a repelling force when an electric current is introduced to the geometrically shaped sections of the body sequentially to mimic the rotation of a conventional helicopter rotor resulting in
the equalization of the vortexes around the disk body that make up the force of gravity. When powered on the Disk is able to able to hover and take flight with no sound or moving parts.
